(19) United States
(12) Patent Application Publication
(10) Pub. No.: US 2011/0204097 A1
(43) Pub. Date: Aug. 25, 2011

(54) DISPENSER ASSEMBLY WITH PLUNGER HAVING BEADED PORTION

(76) Inventors: John David Buehler, Bridgeton, NJ (US); David A. Manera, Petersburg, NJ (US)

(21) Appl. No.: 12/711,713

(22) Filed: Feb. 24, 2010

(51) Int. Cl. B67D 7/58

(52) U.S. Cl. 222/386

(57) ABSTRACT

A dispenser assembly for liquid products is disclosed. Such a dispenser assembly may include an elongated barrel, and an elongated plunger positioned therein with the elongated plunger having a flexible sealing lip disposed at an end thereof. The sealing lip may have a beaded portion providing for easier movement of the plunger within the barrel while creating an effective seal between the plunger and the barrel. In an embodiment, the cross-section of the beaded portion is oval and the thickness of the flexible sealing lip tapers inwardly towards it distal end. The flexible sealing lip may be curved in the shape of an arc of a circle.

### TECHNICAL FIELD

The present invention relates to dispenser assemblies for dispensing liquid products, such as oral medicines.

### BACKGROUND

Dispenser assemblies are frequently used for dispensing liquids such as medicines. These dispenser assemblies can be used in various settings where the administration of medicine is required, for example, hospitals and homes. Historically, dispenser assemblies for dispensing injectable medicines generally comprise an elongated, hollow barrel and a plunger that moves within the hollow barrel during filling and dispensing of the medicine. The plunger has radially outwardly projecting lugs or ribs which engage and seal against the interior cylindrical surface of the hollow barrel during axial movement of the plunger in the barrel during filling of the dispenser assembly or dispensing of medicine from the dispensing assemble.

Numerous considerations go into the design and manufacture of dispenser assemblies. One consideration is the seal that is created between the barrel and the plunger when the plunger moves in the barrel. The seal is necessary to effectively dispense the medicine and prevent liquid from leaking past the plunger into the barrel when the plunger moves in the barrel.

The problem of leakage is acerbated when a force is exerted on the plunger rod and plunger to move the plunger in dispensing the medicine from the dispenser assembly. The pressure of the liquid medicine is thus increased and which, in turn, increases the possibility of the liquid medicine leaking past the seal between the plunger and the barrel in the direction away from the direction that the medicine is being dispensed from the dispenser assembly.

Leakage must be eliminated for a variety of reasons. Too tight of a seal increases the frictional force between the plunger and the barrel and increases the force it takes to move the plunger within the barrel. A dispenser assembly too tight of a seal results in high frictional forces between the barrel and the plunger and is therefore disadvantageous because the user must exert higher forces to move the plunger in the barrel thereby making it physically harder to actuate the plunger. However, a loose seal between the barrel and plunger increases the chances of the liquid leaking from the dispensing assembly or leaking past the seal between the plunger and the barrel. Leakage is disadvantageous for a variety of reasons.

Consequently, it would be advantageous to have a dispensing assembly that provides a tight, effective seal between the plunger and the hollow barrel to prevent leakage therebetween and yet which contributes minimal frictional force to allow for easy movement of the plunger within the hollow barrel.

### SUMMARY

The present invention provides an improved dispenser assembly for dispensing liquid products such as medicines. The present invention provides a dispenser assembly that reduces the amount of force required to move the plunger inside the barrel. At the same time, the present invention provides a dispenser assembly with a seal between the plunger and the barrel sufficient to prevent leakage of the medicine.

In one embodiment of the present invention, the dispenser assembly includes an elongated barrel and an elongated plunger. The elongated plunger includes a flared sealing lip disposed at one end. In one embodiment, the flared sealing lip on the plunger may have a beaded portion on the lip that creates the seal between the plunger and the barrel when the plunger is located in the barrel. The beaded portion of the sealing lip reduces the amount of material on the sealing lip in contact with the barrel relative to a sealing lip that does not have a beaded portion. By reducing the amount of material on the plunger that is in contact with the barrel, the amount of frictional force required to move the plunger in the barrel is reduced. The reduction of frictional force in turn reduces the amount of force necessary to move the plunger within the barrel. Consequently, the beaded portion of the sealing lip makes it easier to slide the plunger within the barrel thus making it easier to dispense the liquid from the dispenser assembly. At the same time, the beaded portion of the sealing lip increases the seal pressure of the dispensing assembly, i.e. the pressure between the plunger and the barrel. An adequate seal pressure prevents the liquid from leaking from the barrel while the plunger is actuated in the barrel.

In another embodiment of the invention, the dispenser assembly includes an elongated barrel and an elongated plunger having a sealing lip disposed with a beaded portion that defines an outer diameter of the sealing lip. In this embodiment, when the plunger is actuated in the barrel the outer diameter of the beaded portion engages the inner wall of the barrel as the plunger moves within the barrel.

In yet another embodiment of the invention, the dispenser assembly includes an elongated barrel having an internal cross-sectional diameter and a one piece elongated plunger having a body portion, a flared sealing member disposed at a tip portion of the body portion, and a sealing bead defined on the sealing member disposed circumferentially around the tip portion. Further, an air gap is defined between the sealing bead and the tip portion.

In a still further embodiment, the dispenser assembly includes an elongated barrel having an internal cross-sectional diameter and a one piece elongated plunger having a body portion, a flared sealing member disposed at a tip portion of the body portion, and a sealing bead defined on the sealing member disposed circumferentially around the tip portion with the sealing bead being oval in cross section.

In yet a still further embodiment, the dispenser assembly includes an elongated barrel having an internal cross-sectional diameter and a one piece elongated plunger having a body portion, a flared sealing member disposed at a tip portion of the body portion where the tip portion is radially arced and its thickness tapers inwardly toward the distal end of the tip portion.

### BRIEF DESCRIPTION OF THE DRAWINGS

FIG. 1 illustrates a cross sectional side view of a plunger of a dispenser assembly constructed in accordance with one embodiment of the present invention;

FIG. 2 illustrates a cross sectional view of a barrel of a dispenser assembly in accordance with one embodiment of the present invention;

FIG. 3 illustrates an expanded cross sectional view of an existing plunger tip;

FIG. 4 illustrates an expanded cross sectional view of a plunger tip of a dispenser assembly in accordance with one embodiment of present invention;

FIG. 5 illustrates a cross sectional side view of an existing plunger partially inserted into a barrel of a dispenser assembly;

FIG. 6 illustrates a cross sectional side view of a plunger tip partially inserted into a barrel of a dispenser assembly in accordance with one embodiment of the present invention;

FIG. 7 is a cross sectional view of a further exemplary embodiment of a plunger tip of a dispenser assembly in accordance with one embodiment of the present invention; and

FIG. 8 illustrates a cross sectional side view, cut away, of the plunger tip of FIG. 7 partially inserted into a barrel of a dispenser assembly in accordance with one embodiment of the present invention.

### DETAILED DESCRIPTION OF ILLUSTRATIVE EMBODIMENTS

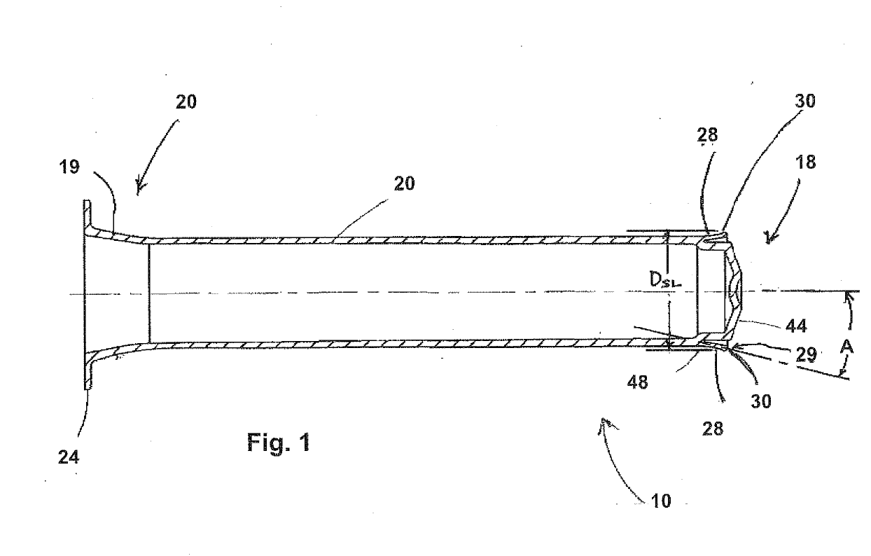

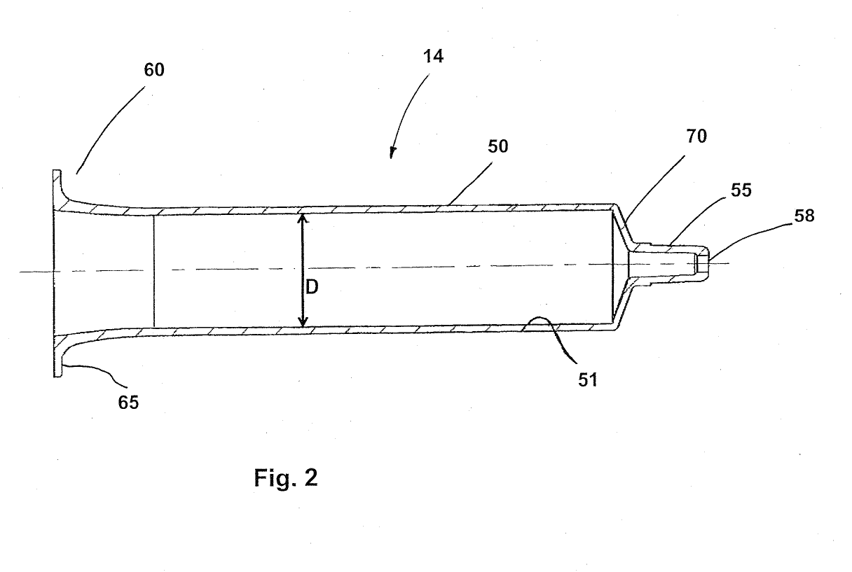

Referring now to the drawings, there is shown in FIGS. 1 and 2, a cross sectional, side view of a plunger 10 and a cross sectional, side view of a barrel 14, respectively, to illustrate the individual components of the dispenser assembly of one embodiment of the present invention. As will be seen, a dispenser assembly is constructed by the insertion of the plunger 10 into the barrel 14.

As such, plunger 10 has an elongated body 15 preferably made of a high-density polyethylene, although numerous other suitable plastic and other materials could be used. The plunger 10 has a tip portion 18 at one end and a base portion 20 at the other end. The base portion 20 of the plunger 10 can include an outwardly flared portion 19 and a circumferentially extending wall 24 to aid the user in actuating the plunger 10 when positioned within the barrel 14. Typically, a user will exert a force on the extending wall 24 with the thumb to move the plunger 10. However, numerous ways to actuate the plunger 10 are contemplated.

The tip portion 18 of the plunger 10 includes a flexible sealing lip 28 for aiding in the formation of a seal that is made between the plunger 10 and the barrel 14 when the plunger 10 is positioned within the barrel 14. The sealing lip 28 has a diameter D_{SL}. The sealing lip 28 extends slightly outwardly so as to project axially from the plunger 10 at the juncture 48 of the cylindrical elongated body 15. The distal tip 29 of the sealing lip 28 is spaced outwardly from a nose portion 44 so that when the plunger 10 is fully seated in the barrel 14, the sealing lip 28 exerts a bias against the inner surface of the barrel 14 to assist in forming a seal as will later become clear.

In one embodiment, the sealing lip 28 projects outwardly at an angle A of about ten degrees (10°) to the longitudinal axis of the plunger 10. However, it is contemplated that the sealing lip 28 could extend from the longitudinal axis of the plunger 10 at other suitable angles.

Further, in one embodiment of the invention, the sealing lip 28 includes an annular beaded portion 30 formed thereon. The beaded portion 30 will be described more fully below. In one embodiment of the present invention, as described below, the beaded portion 30 is a rounded protrusion at the distal tip 29 of the sealing lip 28 furthest from juncture 48.

The plunger 10, as illustrated, has an extended portion or bulbous nose portion 44 at its tip portion 18. The nose portion 44 is inwardly offset from the side wall of the elongated body 15 as shown. In one embodiment, the cross sectional thickness of the nose portion 44 is slightly greater than the cross sectional thickness of cylindrical elongated body 15 of the plunger 10. The nose portion 44 will be described more fully below.

In the embodiment shown in FIG. 1, the plunger 10 is generally cylindrical with a uniform diameter. Any number of differing shapes of the plunger 10 can be used with the present invention. For example, it is also contemplated that the body of the plunger 10 may be solid with the cross sectional shape of an “X.”

Referring specifically to FIG. 2, the barrel 14 is shown and is preferably made of a plastic material and comprises a generally cylindrical, elongated side wall 50 having a bore 51 of generally uniform diameter D for its length. It should be noted that the diameter D is less than the diameter D_{SL} so that the sealing lip 28 exerts an outward bias against the barrel to promote the effective seal therebetween. The barrel 14 includes a tip 55 at one end with a discharge opening 58 through which liquid products such as medicine are dispensed. The barrel 14 is outwardly flared at its opposing terminal end 60 forming a circumferentially extending wall 65 to aid the user in actuating the plunger 10 in the barrel 14. Typically, the user will hold the barrel 14 at the extending wall 65 between the index and middle finger of the hand when the plunger 10 is moved in the barrel 14. However, numerous ways to actuate the plunger 10 in the barrel 14 are contemplated.

The barrel 14 also includes an extended ramped wall portion 70. This extended ramped wall portion 70 seats the plunger 10 when the plunger 10 is fully extended into the barrel 14, as will be discussed more fully below. Preferably, as will be described more fully below, the barrel 14 also has color strip markings (not shown) thereon that indicate the volume and/or color of liquid in the barrel. Such markings help the user of the multiple dispenser assemblies to distinguish one from another.

In an exemplary embodiment, the barrel 14 is preferably made of polypropylene and the plunger 10 is preferably made of a high-density polyethylene. It has been found that this combination of materials and the specific configuration facilitate easy sliding of the parts relative to one another. Further the plunger 10 is easy and economical to manufacture by reason of the simple mold design which does not require side action components. The tooling therefore is relatively simple and does not require the complex tooling which prior art dispenser assemblies require. The tooling can accommodate more cavities for a given tonnage and is therefore very economical and cost saving.

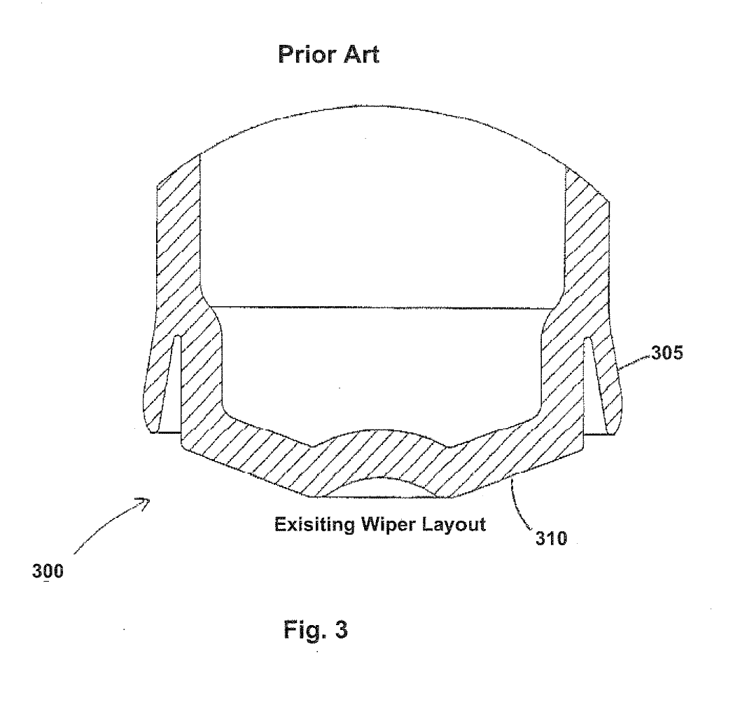

FIG. 3 illustrates an expanded cross sectional view of a conventional plunger tip 300 of a dispenser assembly. As shown in FIG. 3, the plunger tip 300 includes a flexible sealing member 305. However, the illustrated existing sealing member 305 does not include a beaded portion. As the plunger tip 300 travels along the barrel (not shown) during its movement in receiving or dispensing medicine, the flexible sealing member 305 is pressed inwards towards nose portion 310. As such, in a relaxed position (when the plunger is not in the barrel), the diameter of the flexible sealing member 305 is greater than the diameter of the barrel within which the plunger tip 300 moves.

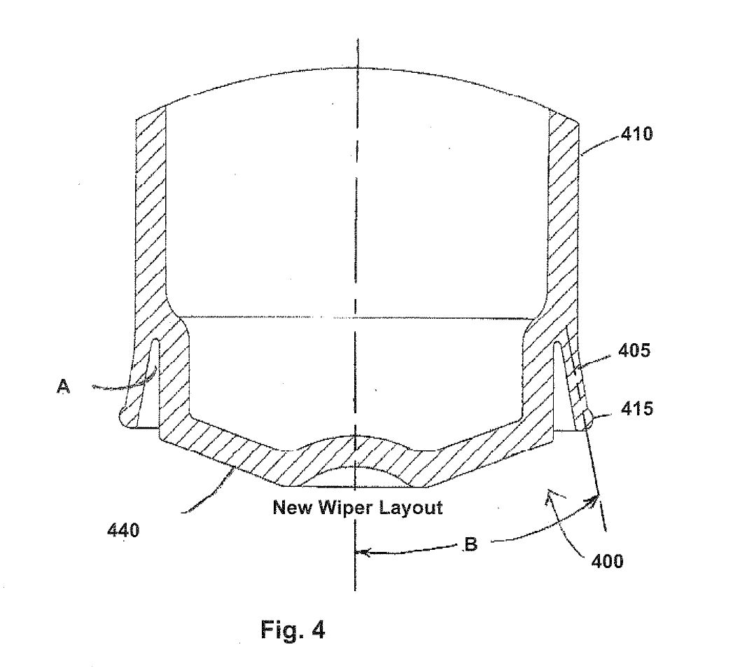

FIG. 4 illustrates an expanded cross sectional view of a plunger tip 400 of a dispenser assembly constructed in accordance with one embodiment of the present invention. As shown in FIG. 4, the plunger tip 400 includes a flexible sealing member 405 that surrounds the body portion 410 of the plunger tip 400. The sealing member 405 is outwardly biased at an angle B from the longitudinal axis of the body portion 410. As such, the sealing member 405 is the outermost portion of the plunger tip 400 and will provide the contact with the barrel (not shown) when the plunger tip 400 is located in the barrel. This concept will be discussed more fully below.

In accordance with one aspect of the present invention, the sealing member 405 includes a beaded portion 415. In one embodiment of the present invention, as shown, the beaded portion 415 is a rounded protrusion on the sealing member 405. In one embodiment, the beaded portion 415 of the sealing member 405 serves as the outermost or distal portion of the sealing member 405.

As such, when the plunger tip 400 moves within a barrel, the beaded portion 415 of sealing member 405 is the only contact between the plunger tip 400 and the barrel. As will be described more fully below, by providing the beaded portion 415 as the sole contact between the barrel and the plunger tip 400, the plunger tip 400 slides more easily in the barrel. As the plunger tip 400 travels within the barrel (not shown) during movement caused by the user, the flexible sealing member 405 is pressed inwards towards nose portion 440 and the beaded portion 415 provides the seal between the barrel (not shown) and the plunger tip 400.

The plunger tip 400, as illustrated, has the extended portion or bulbous nose 440 at its tip or distal end. As will be described more fully below, the bulbous nose 440 fits into an extended portion of the barrel so as to minimize “dead space” and maximize the amount of the fluid that is expended from the dispenser assembly.

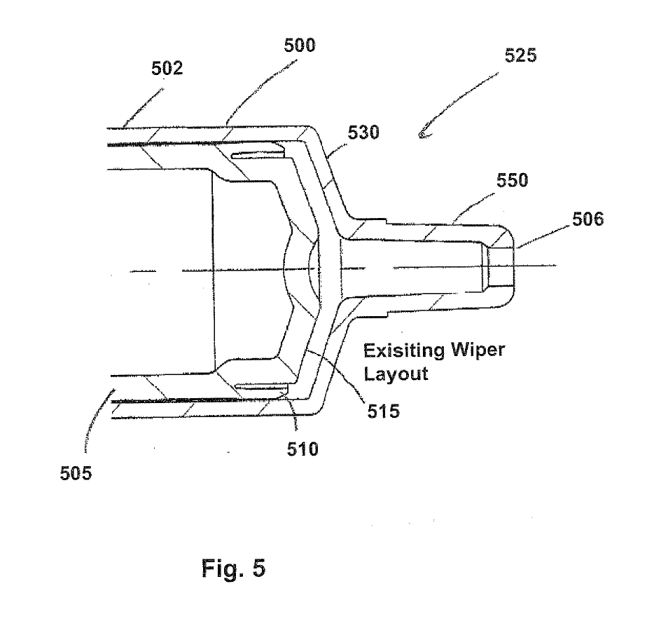

FIG. 5 illustrates a cross sectional side view of a conventional plunger partially inserted into a barrel of a dispenser assembly. As shown, the dispenser assembly 525 comprises an elongated, hollow barrel 500 and a plunger 505 slidably mounted in the barrel 500. The barrel 500, as illustrated, has an elongated, generally cylindrical body 502. The barrel 500 includes a tip 550 having a discharge opening 506 and is connected to the barrel cylindrical body 502 by a downwardly flared conical connecting wall 530.

As can seen in FIG. 5, when the plunger 505 is inserted into the barrel 500, the flexible sealing member 510 flexes inwardly toward the nose portion 515 of the barrel 505. When the flexible sealing member 510 flexes inward during movement wherein a portion of the sealing member 510 is in contact with the barrel 500. This contact provides the seal between the barrel 500 and the plunger 505 that prevents leakage when the plunger 505 is moved.

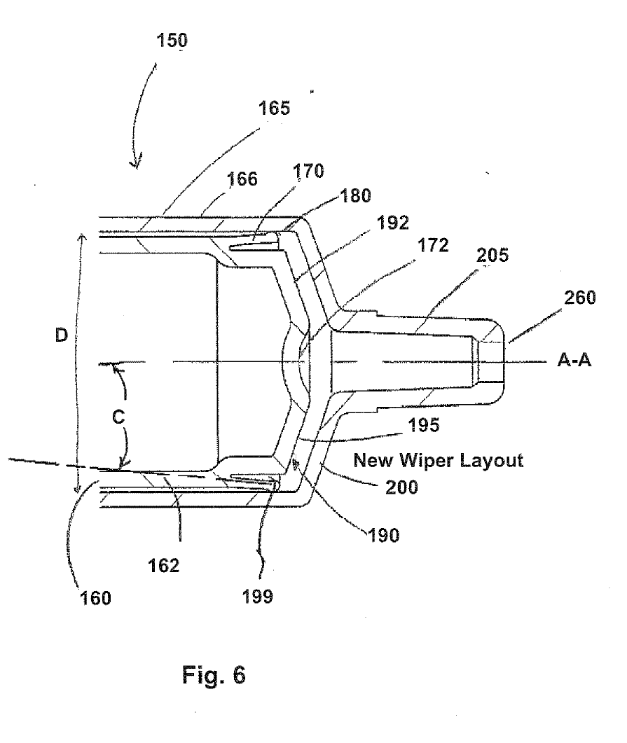

Referring now to FIG. 6, there is shown a cross sectional side view of a plunger tip partially inserted into a barrel of a dispenser assembly in accordance with the present invention is shown. As shown, a dispenser assembly 150 comprises an elongated, hollow barrel 165 and a plunger 160 slidably mounted in the barrel 165. The barrel 165, as illustrated, has an elongated, generally cylindrical body 166. The barrel 165 includes a tip 205 having a discharge opening 206 and is connected to the barrel cylindrical body 166 by a downwardly flared conical connecting wall 200. In one embodiment of the present invention, the barrel 165 is preferably made of polypropylene. However, numerous suitable materials could be used to make the barrel in accordance with the present invention.

The plunger 160 has an elongated body 162 having a generally uniform diameter which has an outwardly flared section or sealing lip 170 at its open end and terminates in a circumferentially extending radially outwardly directed wall (not shown) serving as a finger grip for the user to activate the plunger in the barrel. The flexible sealing lip 170 can be formed integrally with the plunger and in the relaxed state projects at an angle C relative to the axis A-A of the plunger 160.

The tip end 190 of the plunger 160 has a circumferentially extending wall 195 offset radially to provide a circumferentially extending space or pocket 199 between the sealing lip 170 and tip end 190. The pocket 199 provides more space for the sealing member 170 to flex when the plunger 160 is positioned in the barrel 165. The tip end 190 has raised a central indentation 172.

As shown in FIG. 6, the plunger 160 is hollow and generally cylindrical in shape. However, numerous plunger shapes are contemplated in accordance with the present invention. For example, the plunger could be a solid structure made of two substantially perpendicular planar portions having a “X” cross-sectional shape.

In accordance with one embodiment of the present invention, the sealing lip 170 includes a beaded portion 180 thereon. The beaded portion 180 as shown is a rounded protrusion on the sealing lip 170. In one embodiment of the invention, the beaded portion 180 may provide the sole contact between the plunger 160 and the barrel 165.

The beaded portion 180 of the sealing lip 170 reduces the amount of material on the sealing lip 170 in contact with the barrel 165 relative to a sealing lip that does not have a beaded portion (as shown in FIG. 5). By reducing the amount of material on the plunger 160 that is in contact with the barrel 165, the amount of frictional force required to move the plunger 160 in the barrel 165 is also reduced. The reduction of frictional force, in turn, reduces the amount of force necessary to move the plunger 160 within the barrel 165. Consequently, the beaded portion of the sealing lip makes it easier to slide the plunger in and out of the barrel thus making it easier to dispense the liquid from the dispenser assembly. At the same time, the beaded portion 180 of the sealing lip 170 increases the seal pressure of the dispensing assembly, i.e. the pressure between the plunger and the barrel. An adequate seal pressure prevents the liquid from leaking from the barrel or past the sealing lip 170 when the plunger 160 is actuated in the barrel 165.

In one embodiment as described above, the plunger includes a nose portion 192 on the tip end 190. In this manner, when the plunger 160 is fully inserted into the barrel 165, the nose portion 192 of the plunger 160 extends into and may contact the axially extending wall 195 of the barrel 165. This design reduces dead space and aids in the full expulsion of the liquid from the barrel when dispensing the liquid from the assembly. A reduction in dead space increases the precision in the amount of fluid delivered from the dispenser assembly.

In one embodiment of the present invention, when the plunger is not inserted in the barrel (relaxed position, not shown), the inside diameter D of the barrel 165 is slightly smaller than the external diameter of the beaded portion 180 of the sealing lip 170. As such, when the plunger 160 is inserted into the barrel 165, the flexible sealing lip 170 is flexed toward the nose portion 192 of the plunger 160. In accordance with one embodiment of the invention, the beaded portion 180 thereby creates the sole contact between the barrel 165 and the plunger 160 during actuation.

Similar to the previously described embodiments, the barrel of the dispenser assembly is preferably made of propylene and the plunger is preferably made of a high-density polyethylene. The combination of these materials and the specific configuration of the sealing lip facilitates movement of the parts relative to one another and does not require the close molding tolerances to provide good sliding action.

Consider briefly the use of an oral dosing assembly in accordance with one embodiment of the present invention with the use of FIG. 6. With the plunger 160 fully seated in the barrel 165, the user simply inserts the dispenser assembly (barrel and plunger) into a container holding the medicine to be dispensed. The user then pulls the plunger 160 outwardly with respect to the barrel 165 to draw the desired quantity into the barrel 165. The barrel is graduated in markings to aid in the filling process. The user then simply inserts the tip end 160 into the mouth of a child and pushes the barrel 165 forwardly to dispense medicine.

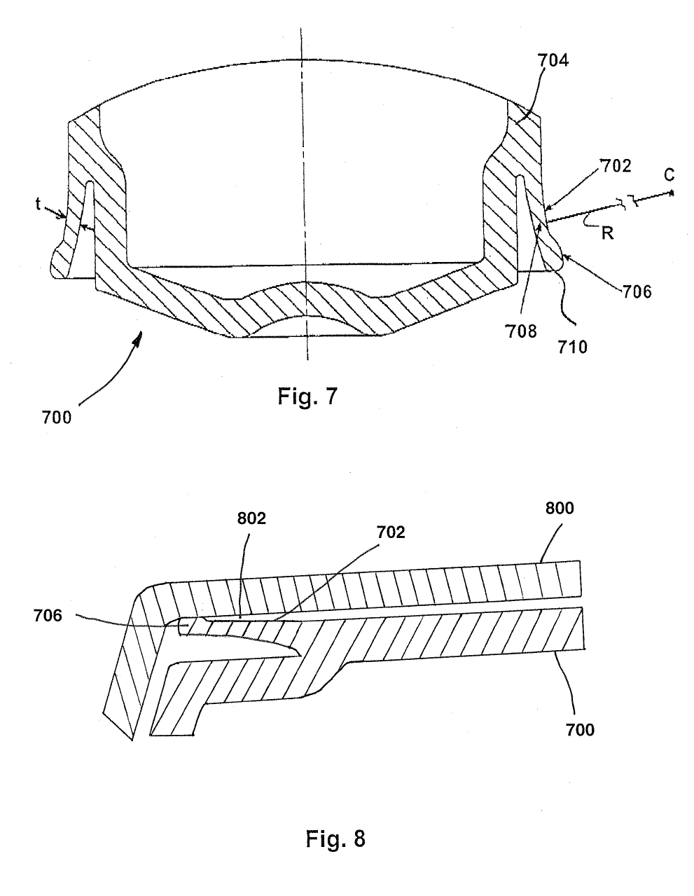

Turning now to FIG. 7, there is shown an expanded cross sectional view of a plunger tip 700 of a dispenser assembly constructed in accordance with one embodiment of the present invention. As shown in FIG. 7, the plunger tip 700 includes a flexible sealing member 702 that surrounds the body portion 704 of the plunger tip 700. The sealing member 702 is outwardly biased with a radial curvature with the radius R having a center C that is located outwardly with respect to the plunger tip 700, that is, there is a concave or outwardly curvature of the flexible sealing member 702 from the body portion 704. As such, as with the prior embodiment, the sealing member 702 is the outermost portion of the plunger tip 700 and will provide the contact with the barrel (not shown) when the plunger tip 700 is located in the barrel. This concept will be discussed more fully below.

In accordance with this embodiment of the present invention, the sealing member 702 includes a beaded portion 706. In this exemplary embodiment of the present invention, as shown, the beaded portion 706 is oval cross section with the longer surface of the oval facing outwardly so as to contact a barrel. As with the FIG. 4 embodiment, the beaded portion 706 of the sealing member 702 serves as the outermost or distal portion of the sealing member 702.

In addition, with this embodiment the wall thickness t along the intermediate portion 708 tapers inwardly in the direction from the body portion 704 toward the outer or distal end 710 of the sealing member 702.

Turning then to FIG. 8, taken along with FIG. 7, there is a cross sectional view, cut away, of the plunger tip 700 of FIG. 7 partially inserted into a barrel 800 of a dispenser assembly in accordance with one embodiment of the present invention.

As such, when the plunger tip 700 moves within the barrel 800, the beaded portion 706 of sealing member 702 is the only contact between the plunger tip 700 and the barrel 800. Since the beaded portion 706 is of an oval cross section, there is more surface area of the beaded portion 706 contacting the barrel 800 to enhance the seal therebetween than that of the FIG. 4 embodiment. In addition, due to the radiased feature of the sealing member 702, while the sealing member 702 bends inwardly, there is addition distance in the space 802 between the sealing member 702 and the barrel 800 than with the embodiment of FIG. 4, even when under compression.

It is noted that even though the dispenser assembly of the present invention has been shown and described in connection with dispensing medicaments for children, the dispensing assembly has many other useful applications for dispensing other types of liquid products. Further, even though the high-density polyethylene and polypropylene are the preferred combination of materials, in some applications, other dissimilar combinations of materials may be used which provide the good sliding action between the flexible wiper lip and the interior wall of the barrel.

Even though particular embodiments of the present invention have been illustrated and described herein, it is not intended to limit the invention and changes and modifications may be made therein within the scope of the following claims.

What is claimed:

1. A dispenser assembly, comprising:
an elongated barrel, and
an elongated plunger having a sealing lip disposed at an end thereof, the sealing lip having a beaded portion thereon, wherein the beaded portion of the sealing lip creates a seal between the plunger and the barrel when the plunger is positioned in the barrel.

2. The dispenser assembly of claim 1, wherein the barrel is made of a first material and the plunger is made of a second material that is different from the first material.

3. The dispenser assembly of claim 1, wherein the beaded portion has an oval cross section.

4. The dispenser assembly of claim 1, wherein the elongated plunger is hollow.

5. The dispenser assembly of claim 1, wherein the elongated barrel has a tip portion.

6. The dispenser assembly of claim 5, wherein the plunger portion has an extended tip that extends into the tip portion of the elongated barrel when the plunger is fully positioned in the elongated barrel.

7. The dispenser assembly of claim 1, wherein the sealing lip is flexible.

8. The dispenser assembly of claim 1, wherein the sealing lip has a thickness that tapers inwardly in the direction outwardly from the tapered plunger.

9. The dispenser assembly of claim 1, wherein the sealing lip is flared outward relative to a longitudinal axis of the plunger.

10. The dispenser assembly of claim 1, wherein the sealing lip is an arc of a radius with a center that is located outwardly with respect to the plunger.

11. The dispenser assembly of claim 1, wherein the sealing lip is integrally disposed at an end of the elongated barrel.

12. The dispenser assembly of claim 1, wherein the sealing tip is biased against the elongated barrel.

13. A dispenser assembly, comprising:
an elongated barrel, and
an elongated plunger having a sealing member disposed at an end thereof, the sealing member being angled relative to a longitudinal axis of the plunger and a sealing lip having a seal ring disposed thereon for creating a seal point between the plunger and the barrel.

14. The dispenser assembly of claim 13, wherein the barrel is made of a first material and the plunger is made of a second material that is different from the first material.

15. The dispenser assembly of claim 13, wherein the barrel is made entirely of a first material and the plunger is made entirely of a second material that is different from the first material.

16. The dispenser assembly of claim 13, wherein the elongated plunger is hollow.

17. The dispenser assembly of claim 13, wherein the elongated barrel has a tip portion.

18. The dispenser assembly of claim 17, wherein the plunger portion has an extended tip that extends into the tip portion of the elongated barrel when the plunger is fully actuated in the elongated barrel.

19. The dispenser assembly of claim 13, wherein the sealing lip is flexible.

20. The dispenser assembly of claim 13, wherein the sealing lip is flared outward relative to a longitudinal axis of the plunger.

21. The dispenser assembly of claim 13, wherein the sealing lip is integrally disposed at an end of the elongated barrel.

22. A dispenser assembly, comprising:
an elongated barrel having an internal cross-sectional diameter; and
a one piece elongated plunger having a body portion, a flared and curved sealing member disposed at a distal end of the body portion, and a sealing bead defined on the sealing member disposed circumferentially around the tip portion, wherein an air gap is defined between the sealing bead and the tip portion.

23. The dispenser assembly of claim 22, wherein a portion of the sealing member is tapered.
